(19) United States
(12) Patent Application Publication
(10) Pub. No.: US 2004/0029555 A1
(43) Pub. Date: Feb. 12, 2004

(54) System and method for supporting mobile internet protocol using multiple separate tunnels

(76) Inventors: Hsien-Ming Tsai, Tainan (TW); Ming-Xian Jiang, Tainan (TW); Jammy Huang, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/379,356

(22) Filed: Mar. 4, 2003

(30) Foreign Application Priority Data
Aug. 9, 2002 (TW) 091118056

(51) Int. Cl. H04Q 7/20

(52) U.S. Cl. 455/403; 455/414.1

(57) ABSTRACT

A system for supporting mobile Internet protocol (mobile IP) using multiple separate tunnels and a method therefor. Separate tunnels can be created between a mobile node and a correspondent node in a communication network compliant to mobile IP, when the mobile node and the correspondent node are communicating with each other. The separate tunnels each are across respective subnets and are used to deliver different packets according to respective packet routing policies. Therefore, the effective bandwidth between the mobile node and its home agent can be increased so as to increase the transmission rate for sending and receiving packets by the mobile node. The mobile node or the home agent routes packets via individual separate tunnels according to respective packet routing policies. The packet routing policies can be individually based on a ratio of respective status parameters of the separate tunnels or of respective costs of the separate tunnels, or on a user-defined manner.

This application claims the benefit of Taiwan application Serial No. 91118056, filed on Aug. 9, 2002.

### BACKGROUND OF THE INVENTION

1. Field of the Invention

The invention relates in general to a system of using mobile Internet protocol (mobile IP) and a method thereof, and more particularly to a system and a method for supporting mobile IP using multiple separate tunnels.

2. Description of the Related Art

The Internet connects a huge number of subnets worldwide to enable packet exchanging among the subnets using packets. Packet exchanging in the Internet is similar to mail exchanging in daily life. In Internet, a sender puts the Internet protocol (IP) address of the receiver into destination address field of the packets and the IP address of the sender into source address field of the packets. In this way, routers in the Internet route the packets to the subnet of the receiver according to the destination address of the packets so that the receiver can receive the packets. In addition, because an IP address of a subnet is fixed geographically and the receiver of the subnet is required to have a fixed connection to the subnet, a receiver is unable to roam across different subnets.

In order to enable a receiver to roam across subnets, mobile Internet protocol (mobile IP) is proposed. The details of mobile IP can be referred to C. Perkins, Ed., “IP Mobility Support for IPv4”, IETF RFC 3220. In a network supporting mobile IP, at least three functional entities are introduced as follows, a mobile node (MN), a correspondent node (CN), and a home agent (HA). An MN can be any mobile device, such as a notebook computer, a digital personal assistant, or its network adapter, for receiving packets from the Internet. The CN is a corresponding device connecting with the MN. The CN can exchange packets with the MN so as to provide the MN with Internet services. The HA is a packet forwarding agent device bound to the home network of the MN. The home network is the subnet which the MN was originally bound to. When the MN moves to other subnets, such subnets, other than the home network, are referred to as visited networks of the MN. In brief, the HA is responsible for routing packets between the MN and the CN when the MN has been away from its home network and has entered a visited network.

The mobile IP is briefly described as follows, according to C. Perkins, Ed., “IP Mobility Support for IPv4”, IETF RFC 3220. Under mobile IP, when an MN is situated in its home network, the MN operates in the same as in connection with a subnet of the Internet. The MN uses an IP address belonging to the home network to obtain Internet services, wherein the IP address is called the home IP address (or simply, home address) of the MN. The home IP address of the MN is notably fixed, regardless of whether the MN is bound to the home network or a visited network. When bound to a visited network, the MN obtains a new IP address from the visited network, the new IP address is referred to as a care-of address. In this case, the MN will periodically register the care-of address with the HA to maintain the binding between the MN and the HA. While the MN is situated in the visited network and communicating with the CN, the packets sent by the CN are routed to the MN's home network according to the MN's home address indicated in the packets and temporarily received by the HA on the behalf of the MN. In addition, based on the binding between the HA and the MN, the HA forwards the received packets to the MN through the tunnel between HA and care-of address of the MN. On the other hand, the packets sent by the MN to CN may be through the same tunnel. Thus, when the MN moves from the previous visited network to a new visited network, the basis for the binding of the MN and the HA changes from the previous care-of address to a new care-of address. In other words, packets are transmitted between the MN and the CN via a new tunnel and the previous tunnel is no longer used.

It should be noted that the above-mentioned mobile IP operation is applied in the disclosure of Jawanda, U.S. Pat. No. 6,243,581, to resolve the problem of an active session of a portable computer having to be terminated when the portable computer moves from a wireless telecommunication network (e.g., GPRS) to a wireless local area network (WLAN). According to Jawanda's disclosure, when a portable computer (i.e. MN) moves from a mobile data communication network (i.e. a previous subnet) to a WLAN (i.e. a new subnet), the connection between the portable computer and the CN can be seamlessly handed off from the previous subnet via an interface to the new subnet via another interface, without terminating the active session. The connection to the previous subnet, however, is not utilized sufficient.

Mobile IP particularly provides multiple simultaneous bindings in order to avoid packet loss when the MN moves from one subnet to another. Multiple identical tunnels between the MN and the HA are allowed in simultaneous bindings when the MN is communicating with the CN. When the HA allows simultaneous bindings, the packets from the CN to the MN are duplicated in the HA, and a separate copy of each arriving packets is sent to the MN through each of the identical tunnels. In this way, the probability of packet loss can be decreased while the MN moves across subnets. That is, new and previously established tunnels between the MN and the HA are maintained and each tunnel transmits identical packets.

According to the mobile IP specification, IETF RFC 3220, the simultaneous binding using multiple identical tunnels is described. After the MN moves from a previously visited network to a new visited network and obtains a new care-of address, the MN registers the new care-of address with HA by sending a registration request in which an S flag is set. On receiving the registration request message, the HA creates a mobility binding for the MN and retains its prior mobility binding(s). If the MN has a connection with the CN, a tunnel between the MN and the HA is established by the binding with the new visited network, and the prior tunnels with the prior visited networks are retained. The packets sent by the CN to the MN are duplicated at the HA and a separate copy of each of the packets is delivered via each of the created and prior tunnels to the MN. Such tunnels are notably identical to each other. That is, the MN may receive multiple identical packets from these tunnels.

Unfortunately, the tunnels between the MN and the HA are mostly established across wireless networks. If simultaneous bindings are used to avoid packet loss resulting from the movement of the MN across subnets, the valuable radio bandwidth of these wireless networks may be ineffectively used. Thus, the effective bandwidth that the MN can use, as well as the transmission rate of packets sent by the MN, will be reduced.

As mentioned above, the mobile IP and related technology are proposed to overcome the corresponding problems described above. However, the radio bandwidth may be ineffectively used or unnecessarily wasted.

Therefore, it is desirable to have a system and method being capable of effectively utilizing the available radio bandwidth in a communication network supporting the mobile IP so that the effective bandwidth can be extended to increase the transmission rate between the mobile node and the communication network.

### SUMMARY OF THE INVENTION

It is therefore an object of the invention to provide a system for supporting mobile Internet protocol (mobile IP) using multiple separate tunnels and a method therefor so that the effective bandwidth, as well as the packet transmission rate for a mobile node, in a communication network can be increased.

In order to increase the effective bandwidth and the packet transmission rate for the mobile node, multilink protocol (MP) may be applied to provide multiple separate tunnels in a communication network supporting mobile IP, wherein the details of multilink protocol is described in K. Sklower et al., “PPP Multilink Protocol (MP)”, IETF RFC 1990.

The invention achieves the above-identified objects by providing a system for supporting mobile IP using multiple separate tunnels and a method therefor. In a communication network supporting mobile IP, when a mobile node (MN) is communicating with a correspondent node (CN) and the MN can access multiple subnets of the communication network, a plurality of separate tunnels can be created between the MN and its home agent (HA) through different corresponding subnets, and the bandwidths of the separate tunnels are thus combined to transmit packets between the MN and the CN. It should be noted that the packets delivered along each separate tunnel may be different packets and need not be a separate copy of the packets. In this way, the bandwidth available for transmission between the HA and the MN is enhanced and the packet transmission delay is thus reduced.

According to the objective of the invention, a method of establishing a plurality of separate tunnels for the MN is provided. In a communication network supporting mobile IP, an MN is capable of accessing a plurality of subnets. The MN includes a plurality of interfaces capable of accessing the subnets, for example, a first interface capable of accessing a first visited network and a second interface capable of accessing a second visited network. When the MN uses the first interface to access the first visited network, a first care-of address is assigned to the MN by the first visited network, corresponding to the first interface. The MN registers with the HA via the first interface so as to create a mobility binding and a first tunnel. When the MN can communicate with the CN via the first tunnel and can access the second visited network via the second interface, a second care-of address is assigned to the MN by the second visited network. The MN sends a registration request message to the HA via the second subnet, wherein a separate field of the registration request message indicates requests for creating a second tunnel, retaining the first tunnel, and making the second tunnel separate from the first tunnel. The HA sends a registration acknowledgement message to the second care-of address of the MN, wherein a separate field, being in the form of flags or extensions, of the registration acknowledgement message indicates that the requests for creating the second tunnel, retaining the first tunnel, and making the second tunnel separate from the first tunnel are allowed. Once the second tunnel is established, the first and the second tunnels can be employed to deliver different packets to the MN and the HA. That is, the MN can route packets via the first and the second tunnels separately and alternately to the HA, and vice versa. Two or more tunnels can be similarly established between the MN and the HA. It should be noted that the MN must re-send a registration request message with a separate field to the HA regularly within a certain period for each tunnel in order to retain the separate tunnels. If a registration request message with respect to a specific tunnel has not been received by the HA within the certain period, the tunnel will be deleted and the resource of the tunnel can be reclaimed. In addition, the separate tunnels created as described above can be via foreign agents so as to support the mobile IP specification, IETF RFC 3220.

When the MN is communicating with the CN, packets exchanged between the MN and the CN are via the HA. According to the invention, after a plurality of separate tunnels are created between the MN and the HA, the HA is used for routing the packets from the CN to the MN through the separate tunnels, and the MN is responsible for routing the packets from the MN via the separate tunnels to the CN. The packet routing policy for the HA and the MN can be based on a ratio of the respective status parameters of the separate tunnels, the costs of the separate tunnels, or a user-defined manner. The respective status parameters of the separate tunnels can be a tunnel length (e.g. number of the intervening routers between two endpoints of the tunnel), a tunnel width (e.g. the transmission rate at which the MN can send or receive data via the tunnel), or a tunneling delay. In this way, the HA collects and sequences the packets from the MN to the CN via the separate tunnels. Meanwhile, the MN collects and sequences the packets from the CN to the MN via the separate tunnels. Moreover, sequencing and fragmentation of packets can be implemented, for example, with the multilink protocol for all separate tunnels, so as to deliver the packets along all tunnels between the MN and the HA.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a system architecture of supporting mobile IP using multiple separate tunnels according to the invention.

FIG. 2 illustrates a protocol stack for supporting mobile IP using multiple separate tunnels according to the invention.

FIG. 3 is a message flow diagram illustrating a method of creating two separate tunnels in a communication network compliant with mobile IP according to the invention.

FIG. 4A illustrates an extension format for use in a registration request message for multiple separate tunneling.

FIG. 4B illustrates an extension format for use in a registration acknowledgement message for multiple separate tunneling.

FIG. 4C illustrates a header format for multiple separate tunneling in a communication network compliant with mobile IP and multilink protocol.

FIG. 5 illustrates a packet format for multiple separate tunneling.

FIGS. 6A and 6B illustrate examples of packet routing policies used by the MN and the HA for multiple separate tunneling.

### DETAILED DESCRIPTION OF THE INVENTION

In order to describe the invention in detail, the following embodiments along with the drawings are intended to indicate that a mobile node obtains Internet services by establishing a plurality of separate tunnels simultaneously through a first subnet, such as a wireless local area network (WLAN), and a second subnet, such as a general packet radio service (GPRS) network.

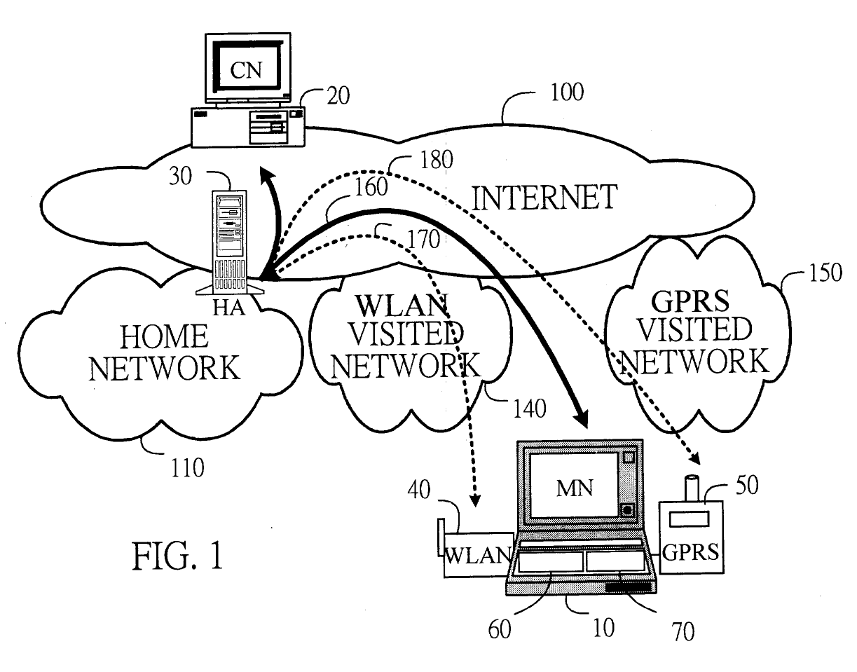

A system architecture is illustrated in FIG. 1 for supporting mobile Internet protocol (mobile IP) using multiple separate tunnels according to an embodiment of the invention. The communication network compliant to mobile IP in this embodiment includes three elements: a mobile node (MN) 10, a correspondent node (CN) 20, and a home agent (HA) 30. The MN 10 is a mobile apparatus or called a mobile device. The CN 20 is a corresponding device connecting with the MN 10. The HA 30 is a packet forwarding agent device attached to the home network of the MN 10. The MN 10 has a first interface, a second interface, a controller, and a memory device, wherein the memory device, the first and the second interfaces are all coupled to the controller. For example, the MN 10 has a WLAN interface 40, a GPRS interface 50, a control chip 60, and a memory chip 70, wherein the control chip 60 is coupled to the WLAN interface 40, the GPRS interface 50, and the memory chip 70.

In addition, the MN 10 can be a mobile apparatus such as a notebook computer, a personal digital assistant, a mobile phone, or a wireless network adapter. The control chip 60 of the MN 10, such as a microprocessor or a system-on-a-chip (SoC), controls the WLAN interface 40 and the GPRS interface 50 according to a program stored in the memory chip 70, as well as using multiple separate tunnels to support mobile IP. The MN 10, as is moving, can use the WLAN interface 40 to access the WLAN 140 or use the GPRS interface 50 to access the GPRS network 150. The CN 20 is attached to the Internet 100 and has an end-to-end connection 160 with the MN 10. The CN 20 exchanges packets with the MN 10 so as to provide Internet services for the MN 10. The HA 30 serves as an agent on a home network 110 for the MN 10. The HA 30, on behalf of the MN 10, relays packets on the home network 110 between the MN 10 and the CN 20, when the MN 10 is away from its home network 110 and travels to a visited network. In FIG. 1, the visited networks that the MN 10 is visiting include the WLAN 140 and the GPRS network 150.

According to the invention, the MN 10, as is under the radio coverage of the visited networks, is notably capable of simultaneously accessing the WLAN 140 and the GPRS network 150 via the WLAN interface 40 and the GPRS interface 50 respectively and creating a first separate tunnel 170 across the WLAN 140 and a second separate tunnel 180 across the GPRS network 150. When the CN 20 and the MN 10 communicate with each other via the HA 30, the HA 30 performs routing of packets destined for the MN 10 to the MN 10 via at least the first separate tunnel 170 and the second separate tunnel 180 separately and alternately. Meanwhile, the MN 10 also performs routing of packets destined for the CN 20 to the HA 30 via at least the first separate tunnel 170 and the second separate tunnel 180 separately and alternately. In this way, the effective bandwidth can be increased between the HA 30 and the MN 10 and the corresponding packet transmission delay is reduced.

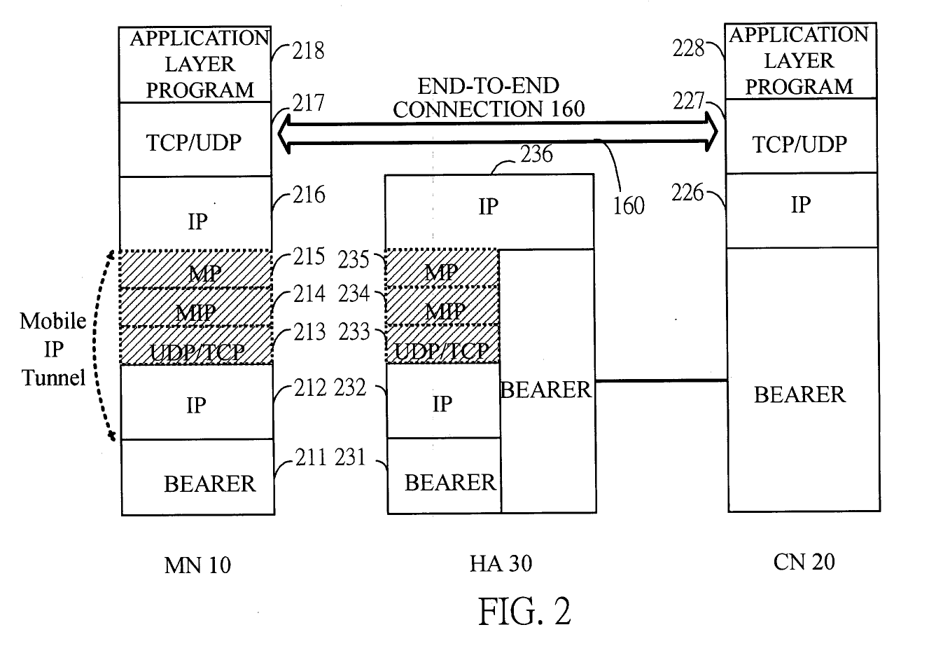

FIG. 2 illustrates a protocol stack for supporting mobile IP using multiple separate tunnels according to the invention. When an application layer program 218 of the MN 10 and an application layer program 228 of the CN 20 employ a transport protocol such as transmission control protocol (TCP) or user datagram protocol (UDP) to establish an end-to-end connection 160, the MN 10 and the CN 20 begin packet exchanging. The Internet protocol (IP) layer 226 of the CN 20 pass packets which take the home address of the MN 10 as their destination addresses to the home network of the MN 10 according to the home address of the MN 10. The IP layer 236 of the HA 30 intercepts these packets and then forwards them through two or more separate tunnels to the IP layer 216 of the MN 10, wherein the protocol stack of these separate tunnels will be described later. Conversely, when the IP layer 216 of the MN 10 sends packets to the CN 20, the packets destined for the CN 20 are first delivered to the IP layer 236 of the HA 30 via the separate tunnels and then the HA 30 forwards the packets to the IP layer 226 of the CN 20. When the MN 10 is on the visited networks, the packets transmitted between the MN 10 and the HA 30 should be delivered through the corresponding separate tunnels across the visited networks. The protocol stack of each separate tunnel includes at least the IP layer for routing, as indicated by a legend “Mobile IP Tunnel” in FIG. 2. In addition, the protocol stack depth can be increased, if needed. For example, UDP or TCP layer, along with MP layer, can be selectively added to the protocol stack of the separate tunnel. In this case, UDP or TCP is employed so as to traverse Network Address Translation/Network Address Port Translation (NAT/NAPT) servers, wherein an IETF draft for Mobile IP NAT/NAPT Traversal can be referred to for details. Mobile Internet protocol (MIP) layer is employed to support IP mobility. In addition, MP is used to enable the separate tunnels to support sequencing, fragmentation, resembling of packets, wherein the details of MP can be referred to “PPP Multilink Protocol (MP)”, IETF RFC 1990.

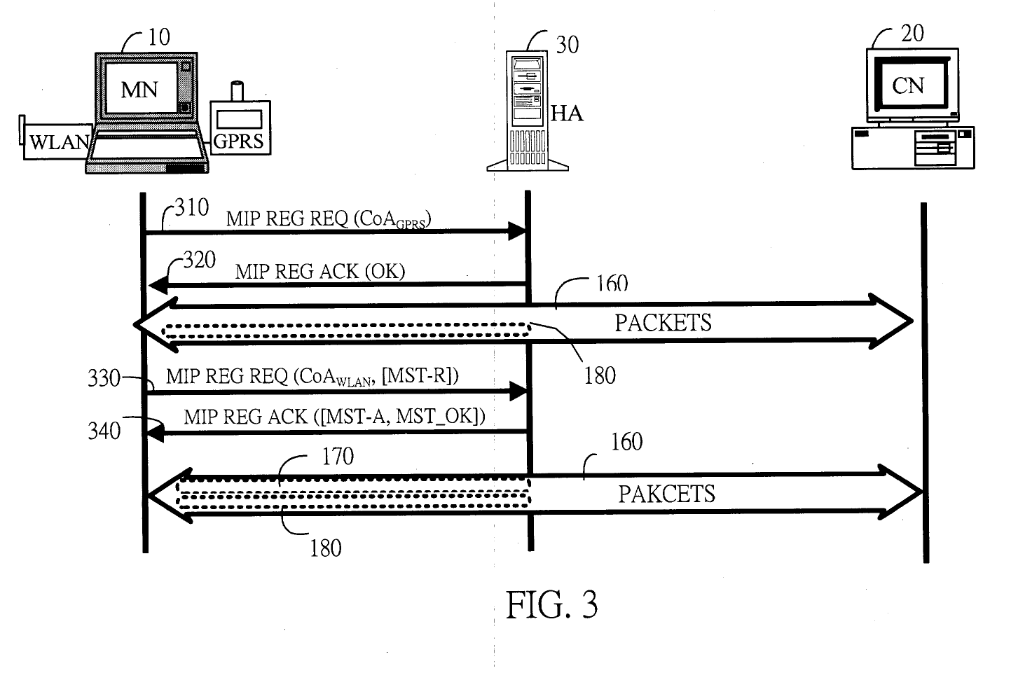

FIG. 3 is a message flow diagram illustrating a method of creating two separate tunnels in a communication network compliant with mobile IP according to the invention. With this method and a packet routing policy later, the MN 10 and HA 30 can serve as a mobile device and a home agent both respectively supporting mobile IP with multiple separate tunnels. As mentioned above, the MN 10 has a WLAN interface 40 and a GPRS interface 50. When the GPRS interface 50 detects signals from the GPRS network 150, the MN 10 uses the GPRS interface 50 to access the GPRS network 150 and the GPRS network 150 assigns a care-of address CoA_{GPRS} to the MN 10. The MN 10 uses the GPRS interface 50 to send a registration request message 310, compliant to mobile IP, to the HA 30, wherein the registration request message 310 includes a field of the care-of address CoA_{GPRS} so as to request a tunnel terminated at the care-of address CoA_{GPRS}. When the HA 30 receives the registration request message 310, the HA 30 sends a registration acknowledgement message 320 to the MN 10, wherein the acknowledgement code OK of the registration acknowledgement message 320 indicates that the tunnel 180 has been successfully created. The MN 10 can then communicate with the CN 20 to exchange packets. If the MN 10 moves into the radio coverage of the WLAN 140 and its WLAN interface 40 detects signals from the WLAN 140, the MN 10 uses the WLAN interface 40 to access the WLAN 140 and the WLAN 140 assigns a new care-of address CoA_{WLAN} to the MN 10. The MN 10 uses the WLAN interface 40 to send a registration request message 330 to the HA 30. In particular, the registration request message 330 includes a field of the care-of address CoA_{WLAN} and a field of multiple separate tunnel request extension (MST-R) so as to request the HA 30 to create another separate tunnel to the care-of address CoA_{WLAN} and retain the previously created tunnel 180. In addition, the tunnel 180 is separate from the tunnel to the care-of address CoA_{WLAN}. In response to the registration request message 330, the HA 30 sends a registration acknowledgement message 340 to the MN 10, wherein the registration acknowledgement message 340 includes the field of multiple separate tunnel acknowledgement extension (MST-A) and the field of an acknowledgement code MST_OK, indicating that the separate tunnel 180 is retained and the separate tunnel 170 has been created successfully. The MN 10 receives the registration acknowledgement message 340. In this way, two separate tunnels 170 and 180 are established between the MN 10 and the HA 30, and packets can be transmitted between the MN 10 and the HA 30 via the separate tunnels 170 and 180, which cross the WLAN 140 and the GPRS network 150 respectively. It should be noted that the MN 10 should request the retaining of all separate tunnels by periodically sending a registration request message for each separate tunnel in a time period. If the HA 30 cannot receive such registration request message within the time period, the corresponding separate tunnel will be deleted and its resource can be reclaimed.

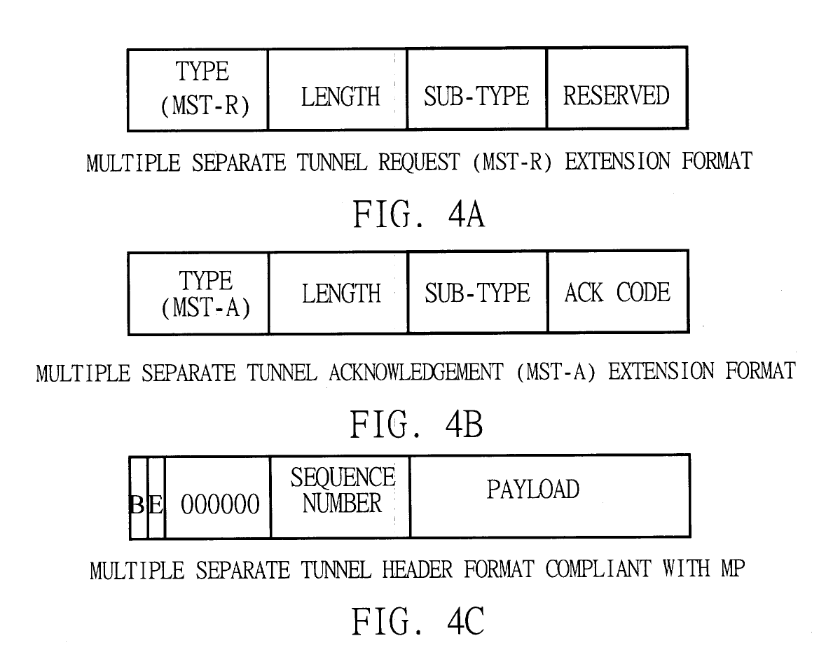

FIG. 4A illustrates a multiple separate tunnel request (MST-R) extension format for use in a registration request message for multiple separate tunneling. The extension includes four fields: type, length, sub-type, and reserved. The type field indicates that the extension is used for MST-R. The length field indicates the length (in bytes) of this extension. The sub-type field indicates whether these separate tunnels use multilink protocol. The reserved field is reserved for future usage. FIG. 4B illustrates a multiple separate tunnel acknowledgement (MST-A) extension format for use in a registration acknowledgement message for multiple separate tunneling. The extension includes four fields: type, length, sub-type, and acknowledge code. The type field indicates that the extension is used for MST-A. The length field indicates the length (in bytes) of this extension. The sub-type field indicates whether these separate tunnels are allowed to use MP in them. The acknowledge code indicates whether the request for multiple separate tunnels is accepted. In addition, a header format is illustrated in FIG. 4C for multiple separate tunneling in a communication network using MP. The header format corresponds to that of MP, wherein the beginning (B) bit is a one bit field set to 1 on the first fragment of a packet, the ending (E) bit is also a one bit field set to 1 on the last fragment of a packet, and the sequence field is a number that is incremented for every fragment transmitted.

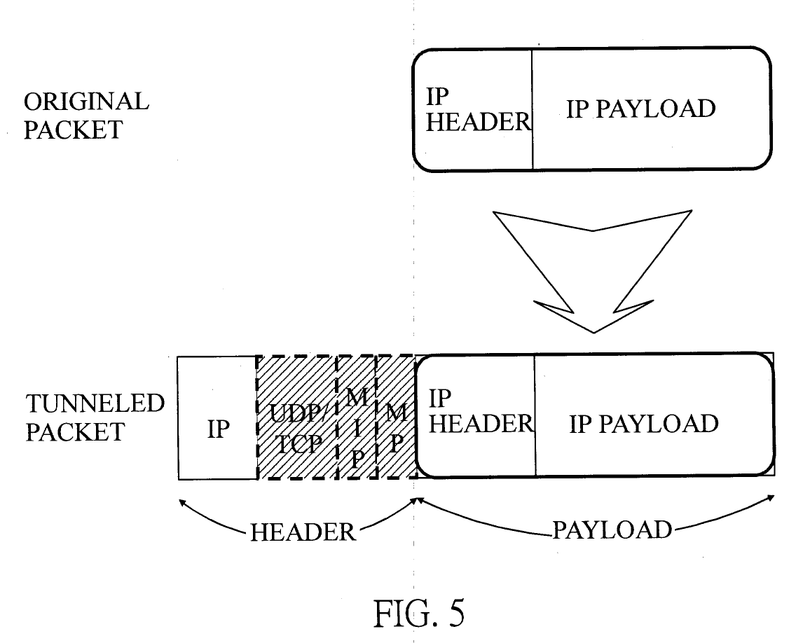

FIG. 5 illustrates a packet format for multiple separate tunneling. In order to deliver an original packet via any of the separate tunnels, the original packet is encapsulated and particularly treated as the payload of a tunneled packet, that is, the packet actually transmitted via the separate tunnels. In addition, such tunneled packet has a header including IP header (care-of address). Moreover, other headers, such as UDP, TCP or MIP, along with MP, can be selectively added to the header of the tunneled packet according to the protocol stack employed for multiple separate tunneling.

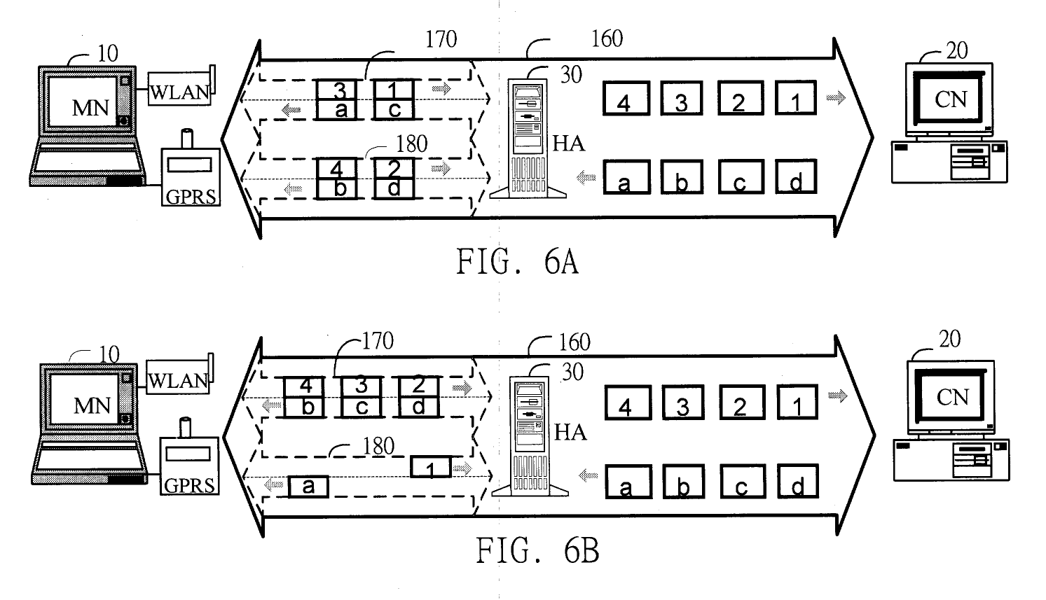

FIGS. 6A and 6B illustrate examples of packet routing policies for multiple separate tunneling of the MN and the HA according the invention. Regarding the connection 160 between the MN 10 and the CN 20, the MN 10 and the HA 30 exchange packets via the separate tunnel 170 across the WLAN 140 and the separate tunnel 180 across the GPRS network 150. That is, when the CN 20 and the MN 10 communicate with each other via the HA 30, the HA 30 performs routing of packets destined for the MN 10 to the MN 10 via at least the separate tunnels 170 and 180 separately and alternately, and the MN 10 performs routing of packets destined for the correspondent node CN 20 to the HA 30 via at least the separate tunnels 170 and 180 separately and alternately. The HA 30 further collects packets sent from the MN 10 via at least the separate tunnels 170 and 180 separately and alternately and further forwards the collected packets to the CN 20. The MN 10 further collects packets sent from the HA 30 via at least the separate tunnels 170 and 180 separately and alternately.

The MN 10 and the HA 30 can adopt its own routing policies to route their packets. In the following examples of packet routing policy, the MN 10 is supposed to send packets 1, 2, 3, and 4 to the CN 20 sequentially. Conversely, the CN 20 is supposed to send packets a, b, c, and d to the MN 10 sequentially.

A fair rotation routing policy is illustrated in FIG. 6A to be employed by the MN 10 and the HA 30. The MN 10 sends packets 1, 2, 3, and 4 sequentially by using the separate tunnels 170 and 180 in fair rotation. That is, the packet 1 is first sent via the separate tunnel 170 and the packet 2 is sent via the separate tunnel 180. The packet 3 is then delivered by the separate tunnel 170 and the packet 4 is sent via the separate tunnel 180. The other packets are similarly sent via the two separate tunnels 170 and 180 alternatively. Conversely, the CN 20 sends packets a, b, c, and d destined for the MN 10 sequentially. The HA 30 intercepts the packets a, b, c, and d and sends these packets destined for the MN 10 sequentially by using the separate tunnels 170 and 180 in fair rotation. First, the packet a is sent via the separate tunnel 170 and the packet b is sent via the separate tunnel 180. The packet c is then put on the separate tunnel 170 for delivery and the packet d is sent via the separate tunnel 180. The other packets are similarly delivered via the two separate tunnels 170 and 180 alternatively. The MN 10 collects and reorders the packets received via the two separate tunnels 170 and 180.

Referring to FIG. 6B, a ratio rotation routing policy is used by the MN 10 and the HA 30 according to the respective status parameters of the separate tunnels. The separate tunnels are used to send packets according to a ratio of respective status parameters of the separate tunnels. For example, the status parameters of the separate tunnels can be respective intervening routers' numbers of the separate tunnels. The status parameters can also be respective transmission rates or respective tunneling delays of the separate tunnels. Take the status parameters as respective transmission rates of the separate tunnel for example. Assume that the separate tunnel 170 across the WLAN provides an average transmission rate of 150 Kbps and the separate tunnel 180 across the GPRS network provides an average transmission rate of 50 Kbps, for packet delivery. A ratio of the respective status parameters, that is, the transmission rates, of the separate tunnels 170 and 180 is 3:1. The MN 10 sends packets 1, 2, 3, and 4 sequentially to the separate tunnels 170 and 180 according to the ratio of the respective transmission rates, that is, 3:1. The packet 1 is firstly sent by the separate tunnel 180 and the packets 2, 3, and 4 are then delivered via the separate tunnels 170. Any other successive packets are delivered via the separate tunnels 170 and 180 in this way. The HA 30, through the separate tunnels 170 and 180, collects, reorders all packets destined for the CN 20, and routes them to the CN 20. The CN 20, conversely, sends packets a, b, c, and d destined for the MN 10 sequentially. The HA 30 intercepts the packets a, b, c, and d and sends these packets destined for the MN 10 sequentially by the separate tunnels 170 and 180 in fair rotation. First, the packet a is sent by the separate tunnel 180 and the packets b, c, and d are delivered via the separate tunnel 170. The other successive packets are similarly delivered via the two separate tunnels 170 and 180. The MN 10 then collects and reorders all the packets sent by the HA 30 via the two separate tunnels 170 and 180. A packet routing policy can be used by the MN 10 and the HA 30 via the separate tunnels on a cost basis. That is, the separate tunnels are used to deliver packets between the MN 10 and the HA 30 according to a routing policy based on respective costs of the separate tunnels. In this case, separate tunnels through visited networks of high costs are not desired to be created or used. Moreover, the MN 10 and the HA 30 can perform routing individually according to a user-defined routing policy, or different packet routing policies, such as those described above.

As disclosed above, a system and a method for supporting mobile IP using multiple separate tunnels are disclosed according to the embodiments of the invention. Separate tunnels can be created between a mobile node and a correspondent node in a communication network compliant to mobile IP, when the mobile node and the correspondent node are communicating with each other. The separate tunnels each are across respective subnets and are used to deliver different packets according to respective packet routing policies. Therefore, the effective bandwidth between the mobile node and the home agent can be increased so as to increase the transmission rate for sending and receiving packets by the mobile node.

Moreover, the multiple separate tunnels can be created, as described in the above embodiment, through other communication sub-networks, such as other fixed or wireless networks, other than a WLAN and a GPRS network, so as to enable the MN 10 to communicate with the CN 20 and provide the Internet services for the MN 10.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A system for supporting mobile internet protocol with multiple separate tunnels, for use in a communication network including a first subnet, a second subnet, and a home network, the system comprising:
a mobile device, having a home address in the home network and being capable of accessing at least the first subnet and the second subnet, wherein the mobile device is capable of obtaining a first care-of address and a second care-of address respectively by accessing the first subnet and the second subnet;
a home agent for selectively maintaining mobility bindings for the mobile device, the mobility bindings including a mobility binding to the first care-of address and a mobility binding to the second care-of address, for establishing at least a first separate tunnel and a second separate tunnel, respectively, between the home agent and the mobile device, and for performing routing of a plurality of packets destined for the mobile device via the first separate tunnel and the second separate tunnel alternately and separately to the mobile device; and
a correspondent device, communicating with the mobile device via the home agent;
wherein when the mobile device accesses the first subnet and the second subnet simultaneously, the home agent creates the first separate tunnel and the second separate tunnel; and
when the correspondent device and the mobile device communicate with each other via the home agent, the home agent performs routing of packets destined for the mobile device to the mobile device via at least the first and second separate tunnels separately and alternately, and the mobile device performs routing of packets destined for the correspondent device to the home agent via at least the first and the second separate tunnels separately and alternately.

2. The system according to claim 1, wherein the mobile device comprises:
a first interface for accessing the first subnet; and
a second interface for accessing the second subnet;
wherein the mobile device uses the first interface to access the first subnet, and the mobile device uses the second interface to access the second subnet.

3. The system according to claim 1, wherein the first subnet is a general packet radio service (GPRS) network and the second subnet is a wireless local area network (WLAN).

4. The system according to claim 1, wherein the home agent further collects packets sent from the mobile device via at least the first and the second separate tunnels separately and alternately and further forwards the collected packets to the correspondent device.

5. The system according to claim 1, wherein the mobile device further collects packets sent from the home agent via at least the first and the second separate tunnels separately and alternately.

6. The system according to claim 17 wherein the mobile device and the home agent perform routing individually according to a routing policy in which said at least the first and the second separate tunnels are used in rotation according to a ratio of respective status parameters of said at least the first and the second separate tunnels.

7. The system according to claim 6, wherein the status parameters each are respective intervening routers numbers of said at least the first and the second separate tunnels.

8. The system according to claim 6, wherein the status parameters each are respective transmission rates of said at least the first and the second separate tunnels.

9. The system according to claim 6, wherein the status parameters each are respective tunneling delays of said at least the first and the second separate tunnels.

10. The system according to claim 1, wherein said at least the first and the second separate tunnels each use at least one foreign agent.

11. A method for supporting mobile internet protocol with multiple separate tunnels, for use in a communication network including a first subnet, a second subnet, a home network, a mobile device and a home agent of the mobile device, the method comprising the steps of:
at the mobile device:
registering a first care-of address obtained from the first subnet with the home agent-so as to request creating a first separate tunnel to the home agent;
obtaining a second care-of address from the second subnet;
registering the second care-of address with the home agent by sending a registration request message to the home agent, wherein the registration request message with a separate field indicates requests for creating a second separate tunnel to the home agent, for retaining the first separate tunnel, and for the second separate tunnel being separate from the first separate tunnel;
at the home agent:
in response to the registration request message, sending a registration acknowledgement message, wherein the registration acknowledgement message with a separate field indicates that the home agent allows the second separate tunnel to be created, retains the first separate tunnel, and makes the second separate tunnel separate from the first separate tunnel; and
routing packets to the mobile device at the home agent and routing packets to the home agent at the mobile device, via at least the first and the second separate tunnels separately and alternately, when a correspondent device and the mobile device communicate with each other via the home agent.

12. The method according to claim 11, wherein the separate field of the registration request message is a flag.

13. The method according to claim 11, wherein the separate field of the registration request message is an extension.

14. The method according to claim 11, further comprising the step of:
retaining a corresponding separate tunnel by periodically resending the registration request message within a required period.

15. The method according to claim 14, further comprising the step of:
deleting the corresponding separate tunnel if the home agent has not received the registration request message within the required period.

16. The method according to claim 11, wherein the first and the second separate tunnels separately use multilink protocol (MP) for packet delivery when the correspondent device and the mobile device communicate with each other via the home agent.

17. The method according to claim 11, wherein the separate tunnel uses user datagram protocol (UDP) for packet delivery when the correspondent device and the mobile device communicate with each other via the home agent.

18. A method for supporting mobile IP using multiple separate tunnels for use in a home agent in a communication network, the communication network including a first subnet, a second subnet, a home network, and a correspondent device, the method comprising the steps of:
receiving a first registration request message, wherein the first registration request message includes a first care-of address of a mobile node and a separate field indicating a request of the mobile device for creating a first separate tunnel;
in response to the first registration request message, sending a first registration reply message, wherein a separate field of the first registration reply message indicates that the home agent accepts the first care-of address and allows a first separate tunnel to be created;
receiving a second registration request message, wherein the second registration request message includes a second care-of address of the mobile node and a separate field indicating requests of the mobile device for creating a second separate tunnel and for retaining the first separate tunnel, and making the first separate tunnel separate from the second separate tunnel;
in response to the second registration request message, sending a second registration reply message, wherein a separate field of the second registration reply message indicates that the home agent allows the second separate tunnel to be created and retains the first separate tunnel, and the second separate tunnel is made separate from the first separate tunnel; and
routing packets destined for the mobile device via at least the first and the second separate tunnels separately and alternately, and collecting packets sent by the mobile device via at least the first and the second separate tunnels separately and alternately so as to forward the packets sent by the mobile device to the correspondent device, when the correspondent device and the mobile device communicate with each other via the home agent.

19. A method for supporting mobile IP using multiple separate tunnels for use in a mobile device in a communication network, the communication network including a first subnet, a second subnet, a home network, a home agent, and a correspondent device, the method comprising the steps of:
registering a first care-of address obtained from the first subnet with the home agent so as to request to create a first separate tunnel;
obtaining a second care-of address from the second subnet;
sending a registration request message to the home agent, wherein the registration request message with a separate field indicates requests for creating a second separate tunnel and retaining the first separate tunnel, and for the second separate tunnel being separate from the first separate tunnel;
receiving a registration reply message, wherein the registration reply message including a separate field indicates that the home agent allows the second separate tunnel to be created, retains the first separate tunnel, and makes the second separate tunnel separate from the first separate tunnel; and
routing packets destined for the correspondent device to the home agent via at least the first and the second separate tunnels separately and alternately and collecting packets sent by the home agent from at least the first and the second separate tunnels separately and alternately, when the mobile device and the correspondent device communicate with each other via the home agent.

20. A mobile apparatus capable of supporting mobile IP using multiple separate tunnels, for use in a communication network including a first subnet, a second subnet, a correspondent device, and a home network with a home agent of the mobile apparatus, the mobile apparatus comprising:
a first interface for accessing to the first subnet;
a second interface for accessing to the second subnet;
a memory device; and
a controller, coupled to the memory device, the first interface, and the second interface, the memory device storing a program for controlling at least the first interface and the second interface, wherein the controller is operative with the program to:
a. use the first interface to access the first subnet so as to obtain a first care-of address;
b. use the first interface to register the first care-of address with the home agent so as to request a first separate tunnel to the first care-of address;
c. use the second interface to access the second subnet so as to obtain a second care-of address;
d. send a registration request message to the home agent so as to register the second care-of address with the home agent, wherein a separate field of the registration request message indicates requests for creating a second separate tunnel to the second care-of address and for retaining the first separate tunnel, and for making the second separate tunnel separate from the first separate tunnel;
e. receive a registration reply message, wherein the registration reply message including a separate field indicates that the home agent allows the second separate tunnel to be created, retains the first separate tunnel, and makes the second separate tunnel separate from the first separate tunnel; and
f. use the first and the second interfaces to route packets to the home agent via at least the first and the second separate tunnels, respectively, in a separate and alternate manner and collecting packets sent by the home agent from at least the first and the second separate tunnels separately and alternately, when the mobile device and the correspondent device communicate with each other via the home agent.
